(19) United States
(12) Patent Application Publication
(10) Pub. No.: US 2026/0046745 A1
(43) Pub. Date: Feb. 12, 2026

(54) INITIAL ACCESS PROCEDURES

(71) Applicant: Samsung Electronics Co., Ltd., Suwon-si (KR)

(72) Inventors: Jiayu Mao, Columbus, OH (US); Hongbo Si, Allen, TX (US)

(21) Appl. No.: 19/271,744

(22) Filed: Jul. 16, 2025

Related U.S. Application Data
(60) Provisional application No. 63/679,790, filed on Aug. 6, 2024.

(51) Int. Cl. H04W 48/08; H04W 74/0833

(52) U.S. Cl. CPC H04W 48/08; H04W 74/0833

(57) ABSTRACT

Apparatuses and methods for initial access procedure(s). A method of a user equipment (UE) in a wireless communication system includes receiving a first synchronization signals and physical broadcast channel (SS/PBCH) block, receiving a first system information block (SIB), and determining, based on the first SIB, a first configuration for an uplink signal. The method further includes transmitting the uplink signal based on the first configuration, receiving a second SS/PBCH block, and receiving a second SIB.

### CROSS-REFERENCE TO RELATED AND CLAIM OF PRIORITY

The present application claims priority under 35 U.S.C. § 119(e) to U.S. Provisional Patent Application No 63/679,790 filed on Aug. 6, 2024, which is hereby incorporated by reference in its entirety.

### TECHNICAL FIELD

The present disclosure relates generally to wireless communication systems and, more specifically, the present disclosure is related to apparatuses and methods for initial access procedure(s), for example, based on dual transceivers.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to initial access procedure(s).

In one embodiment, a user equipment (UE) in a wireless communication system is provided. The UE includes a transceiver configured to receive a first synchronization signals and physical broadcast channel (SS/PBCH) block and receive a first system information block (SIB). The UE further includes a processor operably coupled to the transceiver. The processor is configured to determine, based on the first SIB, a first configuration for an uplink signal. The transceiver is further configured to transmit the uplink signal based on the first configuration, receive a second SS/PBCH block, and receive a second SIB.

In another embodiment, a method of a UE in a wireless communication system. The method includes receiving a first SS/PBCH block, receiving a first SIB, and determining, based on the first SIB, a first configuration for an uplink signal. The method further includes transmitting the uplink signal based on the first configuration, receiving a second SS/PBCH block, and receiving a second SIB.

In yet another embodiment, a base station (BS) in a wireless communication system is provided. The BS includes a processor configured to determine a first configuration for an uplink signal and a transceiver operably coupled to the processor. The transceiver is configured to transmit a first SS/PBCH block, transmit a first SIB, and the first configuration is included in the first SIB, receive the uplink signal based on the first configuration, transmit a second SS/PBCH block, and transmit a second SIB.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example synchronization signal/physical broadcast channel (SS/PBCH) block architecture according to embodiments of the present disclosure;

FIG. 6 illustrates an example on-off keying (OOK) waveform according to embodiments of the present disclosure;

FIG. 7 illustrates an example OOK waveform according to embodiments of the present disclosure;

FIG. 8 illustrates a signal flow of an example procedure for initial access according to embodiments of the present disclosure;

FIG. 9 illustrates a signal flow of an example procedure for initial access according to embodiments of the present disclosure;

FIG. 10 illustrates a signal flow of an example procedure for initial access according to embodiments of the present disclosure;

FIG. 11 illustrates a signal flow of an example procedure for initial access according to embodiments of the present disclosure;

FIG. 12 illustrates a signal flow of an example procedure for initial access according to embodiments of the present disclosure;

FIG. 13 illustrates a signal flow of an example procedure for initial access according to embodiments of the present disclosure;

FIG. 14 illustrates a signal flow of an example procedure for initial access according to embodiments of the present disclosure;

FIG. 15 illustrates a signal flow of an example procedure for initial access according to embodiments of the present disclosure;

FIG. 16 illustrates a signal flow of an example procedure for initial access according to embodiments of the present disclosure;

FIG. 17 illustrates a signal flow of an example procedure for initial access according to embodiments of the present disclosure;

FIG. 18 illustrates a signal flow of an example procedure for initial access according to embodiments of the present disclosure;

FIG. 19 illustrates a signal flow of an example procedure for initial access according to embodiments of the present disclosure;

FIG. 20 illustrates a signal flow of an example procedure for initial access according to embodiments of the present disclosure;

FIG. 21 illustrates a signal flow of an example procedure for initial access according to embodiments of the present disclosure;

FIG. 22 illustrates a signal flow of an example procedure for initial access according to embodiments of the present disclosure;

FIG. 23 illustrates a signal flow of an example procedure for initial access according to embodiments of the present disclosure;

FIG. 24 illustrates a signal flow of an example procedure for initial access according to embodiments of the present disclosure;

FIG. 25 illustrates a signal flow of an example procedure for initial access according to embodiments of the present disclosure;

FIG. 26 illustrates a signal flow of an example procedure for initial access according to embodiments of the present disclosure; and

FIG. 27 illustrates an example method performed by a UE in a wireless communication system according to embodiments of the present disclosure.

### DETAILED DESCRIPTION

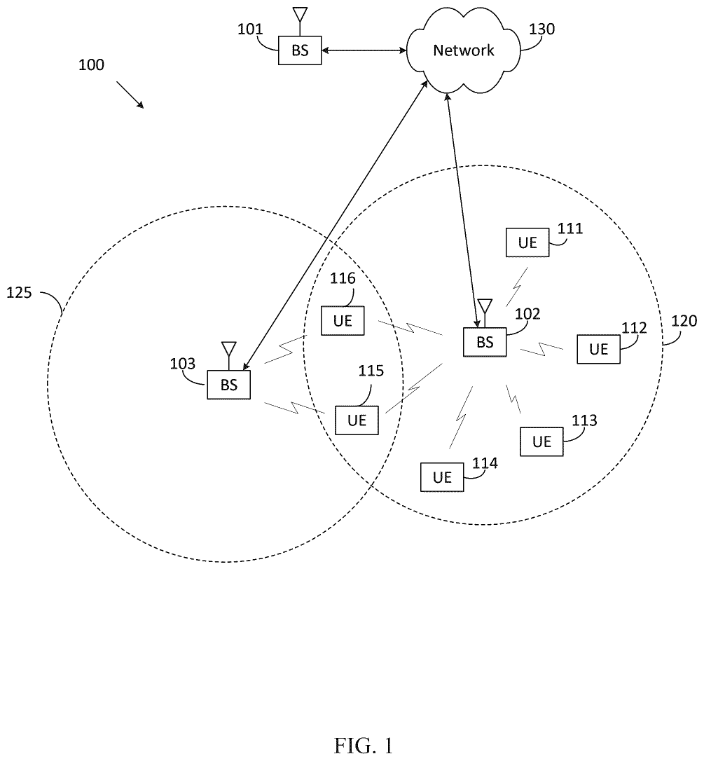

FIGS. 1-27, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v18.0.0, “NR; Physical channels and modulation;” [REF 2] 3GPP TS 38.212 v18.0.0, “NR; Multiplexing and channel coding;” [REF 3] 3GPP TS 38.213 v18.0.0, “NR; Physical layer procedures for control;” [REF 4] 3GPP TS 38.214 v18.0.0, “NR; Physical layer procedures for data;” and [REF 5] 3GPP TS 38.331 v18.0.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device. ” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof to perform initial access procedure(s). In certain embodiments, one or more of the BSs 101-103 include circuitry, programing, or a combination thereof to support initial access procedure(s).

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

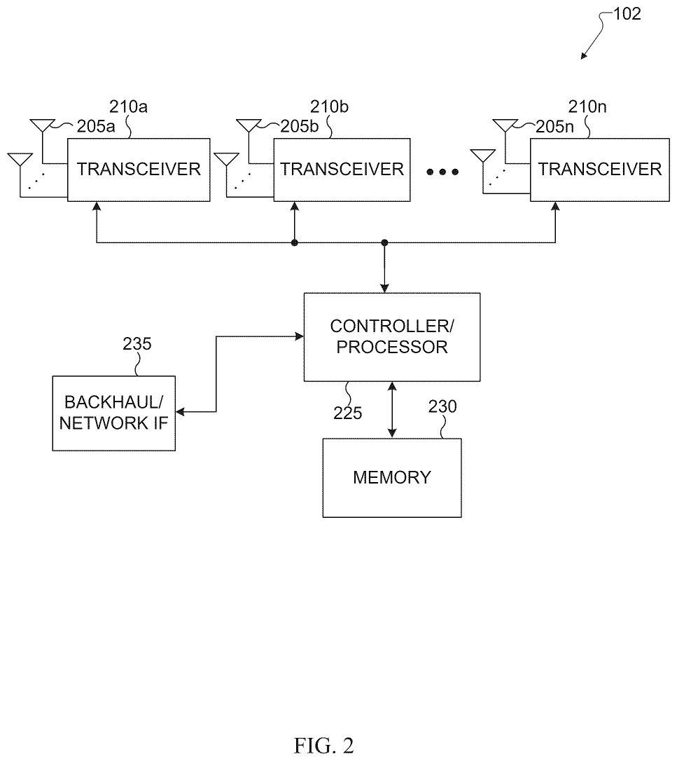

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for initial access procedure(s). Any of a wide variety of other functions could be supported in the gNB 102 by the controller/processor 225.

The controller/processor 225 is also capable of executing programs and other processes resident in the memory 230, such as processes related to supporting initial access procedure(s). The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

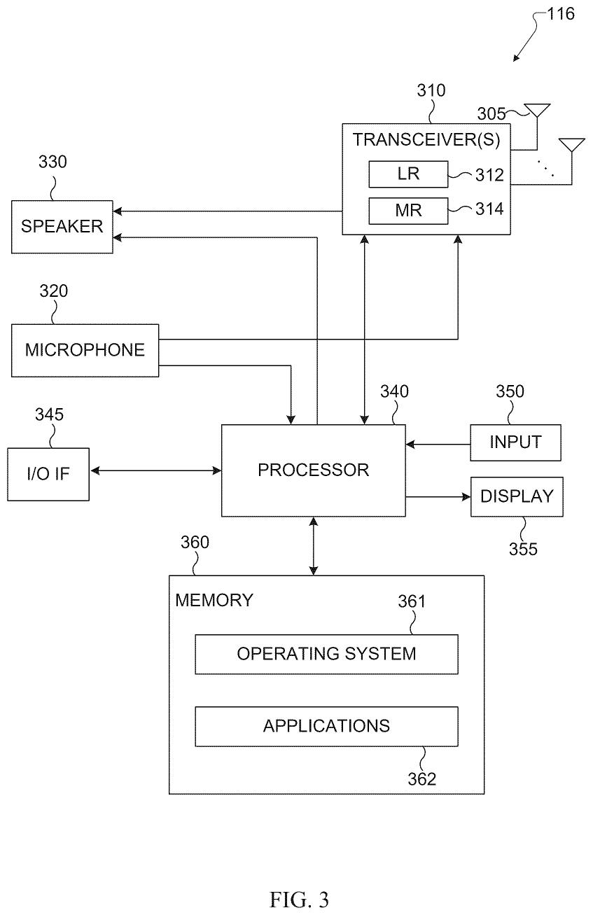

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for utilizing initial access procedure(s) as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

In various embodiments, the transceiver(s) 310 include or are at least one low power receiver (LR) 312 and at least one main receiver (MR) 314. For example, as discussed in greater detail below, the LR 312 may be configured or utilized to receive low power signals (e.g., a low power wake up signal (LP-WUS), a LP-SSB, a LP-SIB, etc.), for example, when the UE 116 is in a sleep state (e.g., such as an ultra-deep sleep state as discussed in greater detail below), while the MR 314 is powered off or in a low power state. For example, in some embodiments, the LR 312 may be a component of the transceiver(s) 310 used or powered on when the UE 116 is in the sleep state while the MR 314 is the transceiver(s) 310 and used when the UE 116 is not in the sleep state. In another example, in other embodiments, the LR 312 may be receiver that is separate or discrete from the transceivers(s) 310 which is the MR 314 used for ordinary reception operations when the UE 116 is not in the sleep state.

Analogously, in such embodiments, the processor 340 includes or is at least one of the low-power processor (LP) 342 and the main processor (MP) 344. For example, in some embodiments, the LR 312 and the MR 314 may be connected to and/or be controlled by the LP 342 and the MP 344, respectively, which are separate and/or discrete processors. In these embodiments, the LP 342 may operate at a lower power state than the MP 344 such that, when the UE is in the sleep state, the MP 344 may be powered off or in a low power state while the LP 342 can process any signals (e.g., such as a LP-WUS) received by the LR 312. In these embodiments, the operation of the LP 342 may consume less power than ordinary operations of the MP 344 would, thereby saving power of the UE 116 in the sleep state while maintaining the ability of the UE 116 to receive and process signals. In other embodiments, the LP 342 and the MP 344 may be components of the processor 340 where the LR 312 and the MR 314 may be connected to and/or be controlled by the LP 342 and the MP 344, respectively. In these embodiments, when the UE 116 is in the sleep state, MP 344 components of the processor 340 are powered off or in a low power state and LP 342 components operate to process signals (e.g., such as a LP-WUS) received by the LR 312. In these embodiments, the operation of the LP 342 components of the processor 340 may consume less power than ordinary operations of the processor 340 including the operations of the MP 344 components would, thereby saving power of the UE 116 in the sleep state while maintaining the ability of the UE 116 to receive and process signals.

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

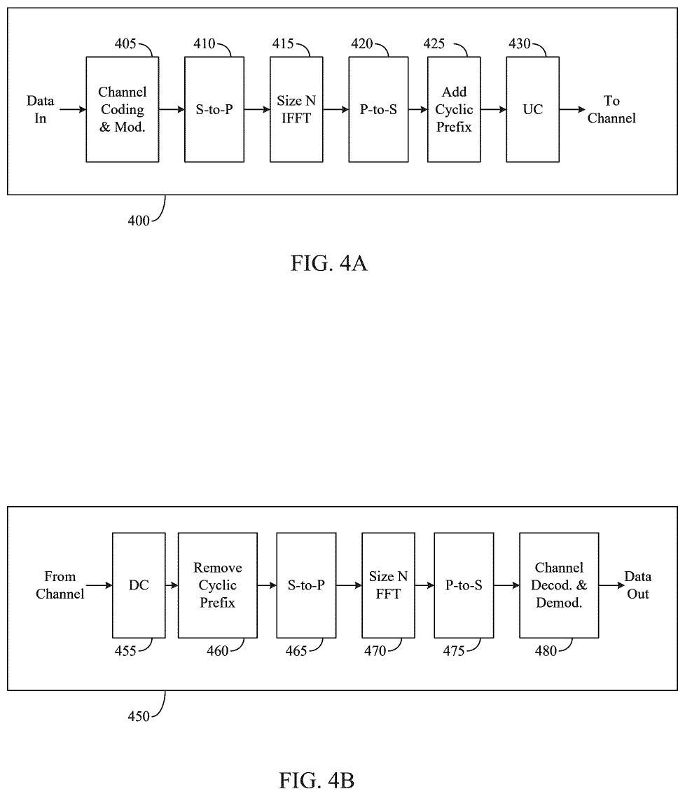

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured for initial access procedure(s) as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

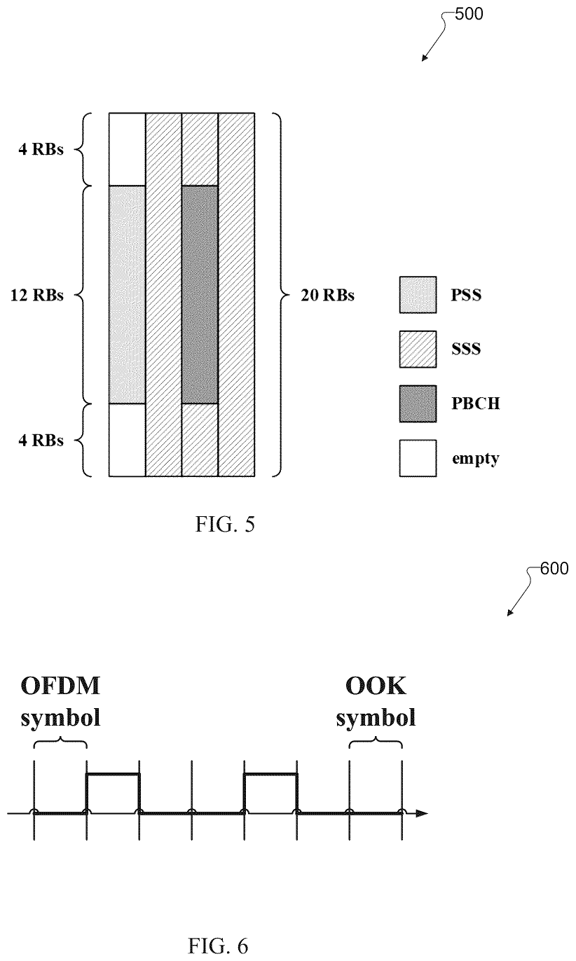

FIG. 5 illustrates an example SS/PBCH block architecture 500 according to embodiments of the present disclosure. For example, SS/PBCH block architecture 500 can be received by any of the UEs 111-116 of FIG. 1. This example is for illustration only and other embodiments can be used without departing from the scope of the present disclosure.

In NR Rel-15, each synchronization signals and physical broadcast channel (SS/PBCH) block compromises of four consecutive orthogonal frequency division multiplexing (OFDM) symbols, wherein the center 12 resource blocks (RBs) of the first symbol are mapped for primary synchronization signal (PSS), the second and forth symbols ae mapped for PBCH, and the third symbol is mapped for both secondary synchronization signal (SSS) and PBCH. An illustration of the SS/PBCH block composition is shown in FIG. 5. The same SS/PBCH composition is applied to supported carrier frequency ranges in NR, which spans from 0.41 GHz to 7.125 GHz as Frequency Range 1 (FR1), and spans from 24.25 to 52.6 GHz as Frequency Range 2 (FR2). In every RB mapped for PBCH, 3 out of the 12 resource elements (REs) are mapped for the demodulation reference signal (DM-RS) of PBCH, wherein the 3 REs are uniformly distributed in the RB and the starting location of the first RE is based on cell identity (ID).

FIG. 6 illustrates an example OOK waveform 600 according to embodiments of the present disclosure. For example, OOK waveform 600 can be received by any of the UEs 111-116 of FIG. 1, such as the UE 111. This example is for illustration only and other embodiments can be used without departing from the scope of the present disclosure.

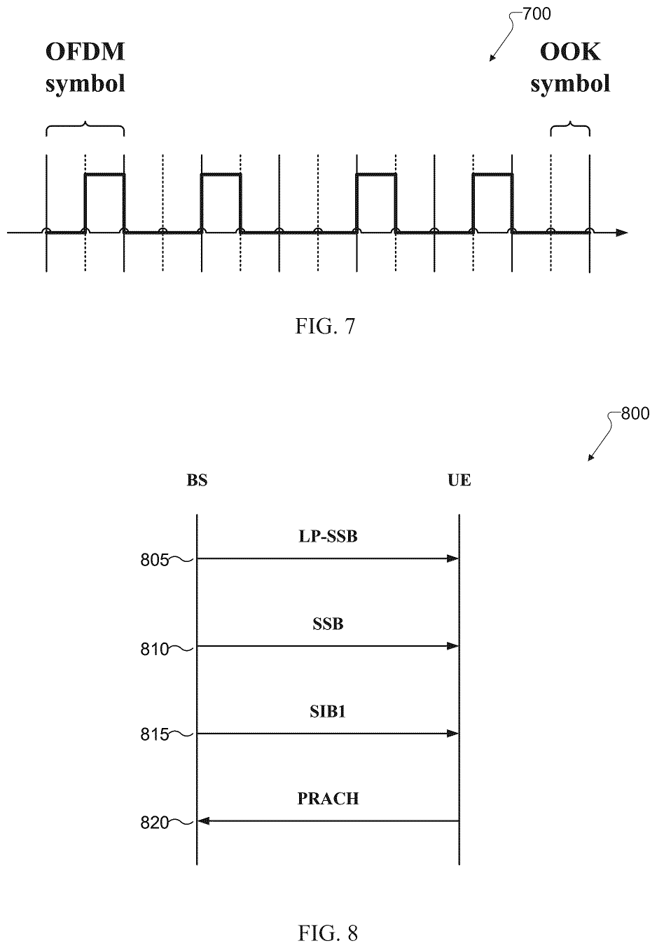

FIG. 7 illustrates an example OOK waveform 700 according to embodiments of the present disclosure. For example, OOK waveform 700 can be received by any of the UEs 111-116 of FIG. 1, such as the UE 116. This example is for illustration only and other embodiments can be used without departing from the scope of the present disclosure.

In NR Rel-19, OOK waveform based low-power synchronization signal (LP-SS) was introduced, wherein the signal can be used for synchronization procedure and radio resource management (RRM) measurement by a low-power receiver (LR). For the OOK waveform, one OFDM symbol can include one or multiple OOK symbols, wherein each OOK symbol corresponds to either ON or OFF. The ON-OFF pattern provided by the OOK waveform can be determined by a binary sequence, and different binary sequences can carry information for the LP-SS. An example of OOK waveform with one OOK symbol in an OFDM symbol is shown in FIG. 6, and an example of OOK waveform with two OOK symbols in an OFDM symbol is shown in FIG. 7.

Embodiments of the present disclosure recognize that, for new generation of wireless communication, saving the energy of a UE is needed. Low-power receiver (LR) and/or low-power transmitter (LT) can be used for initial access, in addition to a main transceiver (MTR). For this purpose, low-power synchronization signal(s) and/or low-power physical broadcast channel can be supported. This disclosure describes the detailed design for initial access procedure using both transceivers.

This disclosure covers several components which can be used in conjunction or in combination with one another, or can operate as standalone schemes. More precisely, the following aspects are included in the disclosure:
Capability of dual transceivers, especially low power transceiver
Procedures of dual transceivers for initial access
Examples of UE procedures

In one embodiment, a device in a network for wireless communication can be implemented with a low-power transmitter (LT) and/or a low-power receiver (LR), in addition to a main transceiver (MTR), wherein the device can be either a user equipment (UE) or a base station (BS). For one instance, when the device is implemented with both the low-power transmitter and the low-power receiver, the device can be denoted as being implemented with low-power transceiver (LTR).

In one example, based on capabilities of devices, including both the BS and the UE, on whether LT, LR, or LTR is implemented, scenarios can be defined for the wireless communication network, illustrated with examples herein.
Scenario 1: the UE is implemented with MTR only, and the BS is implemented with MTR only.
Scenario 2: the UE is implemented with MTR and LR, and the BS is implemented with MTR only.
Scenario 3: the UE is implemented with MTR and LT, and the BS is implemented with MTR only.
Scenario 4: the UE is implemented with MTR and LTR, and the BS is implemented with MTR only.
Scenario 5: the UE is implemented with MTR only, and the BS is implemented with MTR and LR.
Scenario 6: the UE is implemented with MTR and LR, and the BS is implemented with MTR and LR.
Scenario 7: the UE is implemented with MTR and LT, and the BS is implemented with MTR and LR.
Scenario 8: the UE is implemented with MTR and LTR, and the BS is implemented with MTR and LR.
Scenario 9: the UE is implemented with MTR only, and the BS is implemented with MTR and LT.
Scenario 10: the UE is implemented with MTR and LR, and the BS is implemented with MTR and LT.
Scenario 11: the UE is implemented with MTR and LT, and the BS is implemented with MTR and LT.
Scenario 12: the UE is implemented with MTR and LTR, and the BS is implemented with MTR and LT.
Scenario 13: the UE is implemented with MTR only, and the BS is implemented with MTR and LTR.
Scenario 14: the UE is implemented with MTR and LR, and the BS is implemented with MTR and LTR.
Scenario 15: the UE is implemented with MTR and LT, and the BS is implemented with MTR and LTR.
Scenario 16: the UE is implemented with MTR and LTR, and the BS is implemented with MTR and LTR.

For one example, an indication of whether at least one of LT, LR, or LTR is implemented on a BS or for a cell can be included in system information, such as system information block 1 (SIB1), or other system information blocks (SIBs).

For another example, an indication of whether at least one of LT, LR, or LTR is implemented on a BS or for a cell can be included in a dedicated RRC signaling, such as for a configuration of a primary cell (PCell), or a secondary cell (SCell), or a primary secondary cell (PSCell).

For one example, whether at least one of LT, LR, or LTR is implemented on a UE (e.g., the UE 116) can be at least one UE capability. For instance, the at least one UE capability can be reported to a BS, e.g., by a higher layer signaling.

For another example, whether at least one of LT, LR, or LTR is implemented on a UE can be provided to a BS by UE assistant information.

For one example, it can be expected that a UE is implemented with at least one of LT, LR, or LTR by default.

In one embodiment, an initial access procedure can be supported for a BS or a UE implemented with at least one of LT, LR, or LTR.

In the examples of this embodiment, the following signal(s) and/or channel(s) can be transmitted by a LT or LTR, and/or received by a LR or LTR.
Low power synchronization signal block (LP-SSB) (e.g., a second SSB), which may include at least a low power synchronization signal or a set of low power synchronization signals, and may further include a low power physical broadcast channel that is multiplexed with the low power synchronization signal or the set of low power synchronization signals.
Low power system information block (LP-SIB), which may include system information from a BS.
Low power wake up signal (LP-WUS), which can be used for indicating a presence of a UE for accessing a BS and/or for indicating a presence of a BS for a UE to access.
Low power physical random access channel (LP-PRACH), which can be used for initiating a random access procedure. For one instance, for some examples of this disclosure, LP-PRACH can be same as LP-WUS.

In the examples of this embodiment, the following signal(s) and/or channel(s) can be transmitted at least by a MTR, and/or received by at least a MTR. In one example, when the LT, LR, or LTR is implemented with certain configuration, the following signal(s) and/or channel(s) can also be transmitted by a LT or LTR, and/or received by a LR or LTR.
Synchronization signals and physical broadcast channel block (SSB) (e.g., a first SSB).
System information block 1 (SIB1).
Wake up signal (WUS).
Physical random access channel (PRACH).

FIG. 8 illustrates a signal flow of an example procedure 800 for initial access according to embodiments of the present disclosure. For example, procedure 800 can be performed by the UE 111 and the gNB 102 and/or network 130 in the wireless network 100 of FIG. 1. This example is for illustration only and other embodiments can be used without departing from the scope of the present disclosure.

In a first example, a BS transmits at least a set of LP-SSB 805 (e.g., using a LR or LTR or MTR), and a set of SSB 810 (e.g., using a MTR), and a UE, for initial access to the BS, may first receive at least one LP-SSB from the set of LP-SSB 805 (e.g., using a LR or LTR), and then receive at least one SSB from the set of SSBs 810 (e.g., using a MTR). The UE can further receive SIB1 from the BS 815 (e.g., using a MTR), and transmit a PRACH to the BS 820 (e.g., using a MTR). An illustration of this example is shown in FIG. 8.

In one implementation for this example, a UE can acquire downlink synchronization based on LP-SSB and SSB, wherein the UE may acquire a first part of timing information based on the reception of LP-SSB, and acquire a second part of timing information based on the reception of SSB.

In another implementation for this example, a set of configurations for the SSB can be carried and/or indicated (explicitly or implicitly) by the LP-SSB.

In yet implementation for this example, a set of configurations for the SIB1 can be carried and/or indicated (explicitly or implicitly) by the SSB.

In yet another implementation for this example, a set of configurations for the PRACH can be carried and/or indicated (explicitly or implicitly) by the SIB1.

In yet another implementation for this example, the first example can be applicable for at least on of Scenario 2, and/or Scenario 4, and/or Scenario 6, and/or Scenario 8, and/or Scenario 10, and/or Scenario 12, and/or Scenario 14, and/or Scenario 16.

With reference to FIG. 8, an example UE procedure is shown for initial access using dual transceivers.

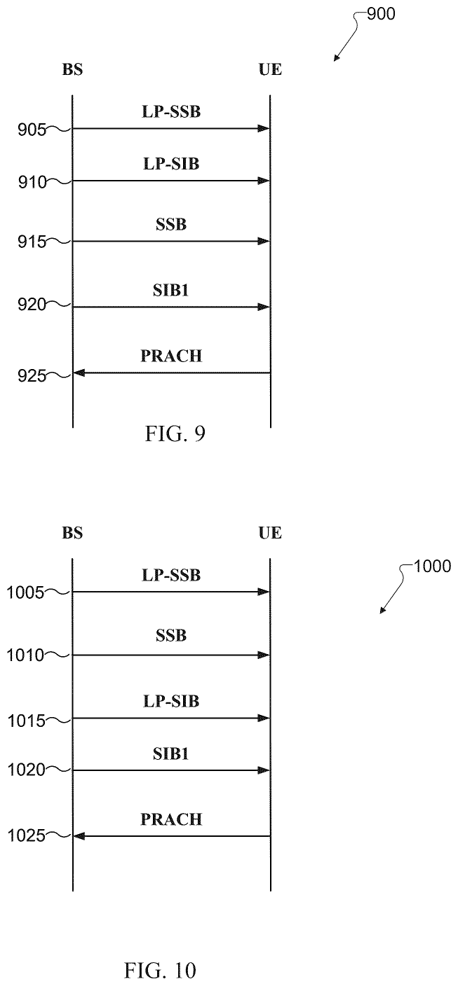

FIG. 9 illustrates a signal flow of an example procedure 900 for initial access according to embodiments of the present disclosure. For example, procedure 900 can be performed by the UE 112 and the gNB 102 and/or network 130 in the wireless network 100 of FIG. 1. This example is for illustration only and other embodiments can be used without departing from the scope of the present disclosure.

In a second example, a BS transmits at least a set of LP-SSB 905 (e.g., using a LR or LTR or MTR), at least a set of LP-SIB 910 (e.g., using a LR or LTR or MTR), and a set of SSB 915 (e.g., using a MTR), and a UE, for initial access to the BS, may first receive at least one LP-SSB from the set of LP-SSB 905 (e.g., using a LR or LTR), next receive at least one LP-SIB from the set of LP-SIB 910 (e.g., using a LR or LTR), and then receive at least one SSB from the set of SSBs 915 (e.g., using a MTR). The UE can further receive SIB1 from the BS 920 (e.g., using a MTR), and transmit a PRACH to the BS 925 (e.g., using a MTR). An illustration of this example is shown in FIG. 9.

In one implementation for this example, a UE can acquire downlink synchronization based on LP-SSB and SSB, wherein the UE may acquire a first part of timing information based on the reception of LP-SSB, and acquire a second part of timing information based on the reception of SSB. The UE can acquire a first part of system information based on the reception of LP-SIB, and acquire a second part of system information based on the reception of SIB1.

In another implementation for this example, a set of configurations for the SSB can be carried and/or indicated (explicitly or implicitly) by the LP-SSB.

In yet another implementation for this example, a set of configurations for the SSB can be carried and/or indicated (explicitly or implicitly) by the LP-SIB.

In yet another implementation for this example, a set of configurations for the LP-SIB can be carried and/or indicated (explicitly or implicitly) by the LP-SSB.

In yet another implementation for this example, a set of configurations for the SIB1 can be carried and/or indicated (explicitly or implicitly) by the SSB.

In yet another implementation for this example, a set of configurations for the SIB1 can be carried and/or indicated (explicitly or implicitly) by the LP-SIB.

In yet another implementation for this example, a set of configurations for the PRACH can be carried and/or indicated (explicitly or implicitly) by the SIB1.

In yet another implementation for this example, the second example can be applicable for at least on of Scenario 2, and/or Scenario 4, and/or Scenario 6, and/or Scenario 8, and/or Scenario 10, and/or Scenario 12, and/or Scenario 14, and/or Scenario 16.

With reference to FIG. 9, an example UE procedure is shown for initial access using dual transceivers.

FIG. 10 illustrates a signal flow of an example procedure 1000 for initial access according to embodiments of the present disclosure. For example, procedure 1000 can be performed by the UE 113 and the gNB 102 and/or network 130 in the wireless network 100 of FIG. 1. This example is for illustration only and other embodiments can be used without departing from the scope of the present disclosure.

In a third example, a BS transmits at least a set of LP-SSB 1005 (e.g., using a LR or LTR or MTR), and a set of SSB 1010 (e.g., using a MTR), and at least a set of LP-SIB 1015 (e.g., using a LR or LTR or MTR), and a UE, for initial access to the BS, may first receive at least one LP-SSB from the set of LP-SSB 1005 (e.g., using a LR or LTR), and then receive at least one SSB from the set of SSBs 1010 (e.g., using a MTR), and next receive at least one LP-SIB from the set of LP-SIB 1015 (e.g., using a LR or LTR). The UE can further receive SIB1 from the BS 1020 (e.g., using a MTR), and transmit a PRACH to the BS 10250 (e.g., using a MTR). An illustration of this example is shown in FIG. 10.

In one implementation for this example, a UE can acquire downlink synchronization based on LP-SSB and SSB, wherein the UE may acquire a first part of timing information based on the reception of LP-SSB, and acquire a second part of timing information based on the reception of SSB. The UE can acquire a first part of system information based on the reception of LP-SIB, and acquire a second part of system information based on the reception of SIB1.

In another implementation for this example, a set of configurations for the SSB can be carried and/or indicated (explicitly or implicitly) by the LP-SSB.

In yet another implementation for this example, a set of configurations for the LP-SIB can be carried and/or indicated (explicitly or implicitly) by the LP-SSB.

In yet another implementation for this example, a set of configurations for the LP-SIB can be carried and/or indicated (explicitly or implicitly) by the SSB.

In yet another implementation for this example, a set of configurations for the SIB1 can be carried and/or indicated (explicitly or implicitly) by the SSB.

In yet another implementation for this example, a set of configurations for the SIB1 can be carried and/or indicated (explicitly or implicitly) by the LP-SIB.

In yet another implementation for this example, a set of configurations for the PRACH can be carried and/or indicated (explicitly or implicitly) by the SIB1.

In yet another implementation for this example, the third example can be applicable for at least on of Scenario 2, and/or Scenario 4, and/or Scenario 6, and/or Scenario 8, and/or Scenario 10, and/or Scenario 12, and/or Scenario 14, and/or Scenario 16.

With reference to FIG. 10, an example UE procedure is shown for initial access using dual transceivers.

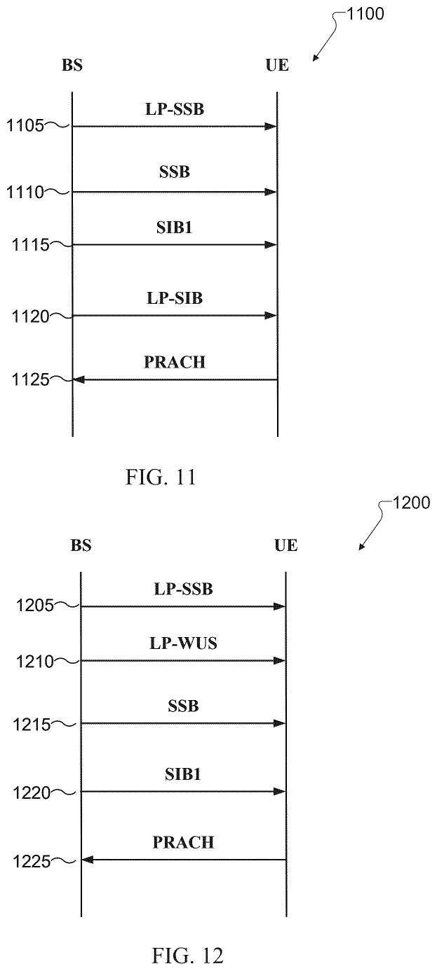

FIG. 11 illustrates a signal flow of an example procedure 1100 for initial access according to embodiments of the present disclosure. For example, procedure 1100 can be performed by the UE 114 and the gNB 102 and/or network 130 in the wireless network 100 of FIG. 1. This example is for illustration only and other embodiments can be used without departing from the scope of the present disclosure.

In a fourth example, a BS transmits at least a set of LP-SSB 1105 (e.g., using a LR or LTR or MTR), and a set of SSB 1110 (e.g., using a MTR), and a SIB1 1115 (e.g., using a MTR), and at least a set of LP-SIB 1120 (e.g., using a LR or LTR or MTR), and a UE, for initial access to the BS, may first receive at least one LP-SSB from the set of LP-SSB 1105 (e.g., using a LR or LTR), and then receive at least one SSB from the set of SSBs 1110 (e.g., using a MTR). The UE can further receive SIB1 from the BS 1115 (e.g., using a MTR), and at least one LP-SIB from the set of LP-SIB 1120 (e.g., using a LR or LTR), and transmit a PRACH to the BS 1125 (e.g., using a MTR). An illustration of this example is shown in FIG. 11.

In one implementation for this example, a UE can acquire downlink synchronization based on LP-SSB and SSB, wherein the UE may acquire a first part of timing information based on the reception of LP-SSB, and acquire a second part of timing information based on the reception of SSB. The UE can acquire a first part of system information based on the reception of LP-SIB, and acquire a second part of system information based on the reception of SIB1.

In another implementation for this example, a set of configurations for the SSB can be carried and/or indicated (explicitly or implicitly) by the LP-SSB.

In yet another implementation for this example, a set of configurations for the LP-SIB can be carried and/or indicated (explicitly or implicitly) by the LP-SSB.

In yet another implementation for this example, a set of configurations for the LP-SIB can be carried and/or indicated (explicitly or implicitly) by the SIB1.

In yet another implementation for this example, a set of configurations for the LP-SIB can be carried and/or indicated (explicitly or implicitly) by the SSB.

In yet another implementation for this example, a set of configurations for the SIB1 can be carried and/or indicated (explicitly or implicitly) by the SSB.

In yet another implementation for this example, a set of configurations for the PRACH can be carried and/or indicated (explicitly or implicitly) by the SIB1.

In yet another implementation for this example, the fourth example can be applicable for at least on of Scenario 2, and/or Scenario 4, and/or Scenario 6, and/or Scenario 8, and/or Scenario 10, and/or Scenario 12, and/or Scenario 14, and/or Scenario 16.

With reference to FIG. 11 an example UE procedure is shown for initial access using dual transceivers.

FIG. 12 illustrates a signal flow of an example procedure 1200 for initial access according to embodiments of the present disclosure. For example, procedure 1200 can be performed by the UE 115 and the gNB 102 and/or network 130 in the wireless network 100 of FIG. 1. This example is for illustration only and other embodiments can be used without departing from the scope of the present disclosure.

In a fifth example, a BS transmits at least a set of LP-SSB 1205 (e.g., using a LR or LTR or MTR), and at least a set of LP-WUS 1210 (e.g., using a LR or LTR or MTR), and a set of SSB 1215 (e.g., using a MTR), and a SIB1 1220 (e.g., using a MTR), and a UE, for initial access to the BS, may first receive at least one LP-SSB from the set of LP-SSB 1205 (e.g., using a LR or LTR), and then receive at least one LP-WUS from the set of LP-WUS 1210 (e.g., using a LR or LTR), and next receive at least one SSB from the set of SSBs 1215 (e.g., using a MTR). The UE can further receive SIB1 from the BS 1220 (e.g., using a MTR), and transmit a PRACH to the BS 1225 (e.g., using a MTR). An illustration of this example is shown in FIG. 12.

In one implementation for this example, a UE can acquire downlink synchronization based on LP-SSB and SSB, wherein the UE may acquire a first part of timing information based on the reception of LP-SSB, and acquire a second part of timing information based on the reception of SSB.

In another implementation for this example, a set of configurations for the SSB can be carried and/or indicated (explicitly or implicitly) by the LP-SSB.

In yet another implementation for this example, a set of configurations for the SSB can be carried and/or indicated (explicitly or implicitly) by the LP-WUS.

In yet another implementation for this example, a set of configurations for the LP-WUS can be carried and/or indicated (explicitly or implicitly) by the LP-SSB.

In yet another implementation for this example, a set of configurations for the SIB1 can be carried and/or indicated (explicitly or implicitly) by the SSB.

In yet another implementation for this example, a set of configurations for the SIB1 can be carried and/or indicated (explicitly or implicitly) by the LP-WUS.

In yet another implementation for this example, a set of configurations for the PRACH can be carried and/or indicated (explicitly or implicitly) by the SIB1.

In yet another implementation for this example, the fifth example can be applicable for at least on of Scenario 2, and/or Scenario 4, and/or Scenario 6, and/or Scenario 8, and/or Scenario 10, and/or Scenario 12, and/or Scenario 14, and/or Scenario 16.

With reference to FIG. 12, an example UE procedure for initial access using dual transceivers.

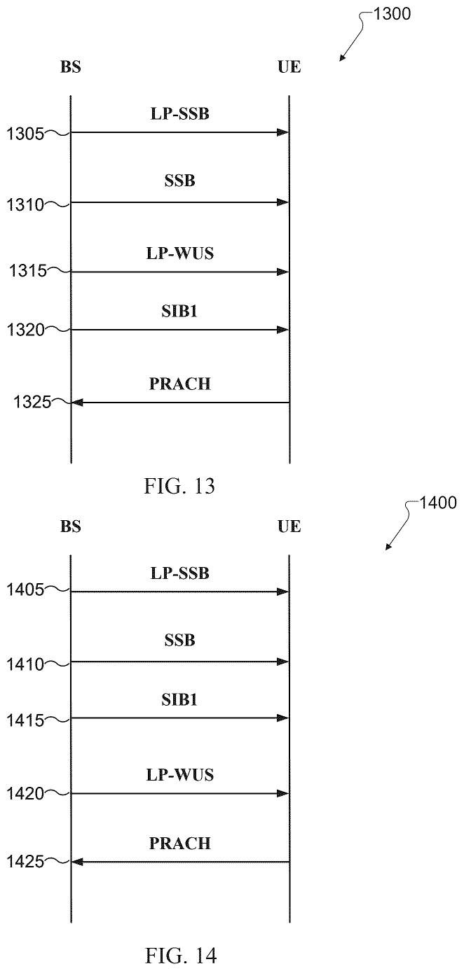

FIG. 13 illustrates a signal flow of an example procedure 1300 for initial access according to embodiments of the present disclosure. For example, procedure 1300 can be performed by the UE 116 and the gNB 102 and/or network 130 in the wireless network 100 of FIG. 1. This example is for illustration only and other embodiments can be used without departing from the scope of the present disclosure.

In a sixth example, a BS transmits at least a set of LP-SSB 1305 (e.g., using a LR or LTR or MTR), and a set of SSB 1310 (e.g., using a MTR), and at least a set of LP-WUS 1315 (e.g., using a LR or LTR or MTR), and a SIB1 1320 (e.g., using a MTR), and a UE, for initial access to the BS, may first receive at least one LP-SSB from the set of LP-SSB 1305 (e.g., using a LR or LTR), and then receive at least one SSB from the set of SSBs 1310 (e.g., using a MTR), and next receive at least one LP-WUS from the set of LP-WUS 1315 (e.g., using a LR or LTR). The UE can further receive SIB1 from the BS 1320 (e.g., using a MTR), and transmit a PRACH to the BS 1325 (e.g., using a MTR). An illustration of this example is shown in FIG. 13.

In one implementation for this example, a UE can acquire downlink synchronization based on LP-SSB and SSB, wherein the UE may acquire a first part of timing information based on the reception of LP-SSB, and acquire a second part of timing information based on the reception of SSB.

In another implementation for this example, a set of configurations for the SSB can be carried and/or indicated (explicitly or implicitly) by the LP-SSB.

In yet another implementation for this example, a set of configurations for the LP-WUS can be carried and/or indicated (explicitly or implicitly) by the SSB.

In yet another implementation for this example, a set of configurations for the LP-WUS can be carried and/or indicated (explicitly or implicitly) by the LP-SSB.

In yet another implementation for this example, a set of configurations for the SIB1 can be carried and/or indicated (explicitly or implicitly) by the SSB.

In yet another implementation for this example, a set of configurations for the SIB1 can be carried and/or indicated (explicitly or implicitly) by the LP-WUS.

In yet another implementation for this example, a set of configurations for the PRACH can be carried and/or indicated (explicitly or implicitly) by the SIB1.

In yet another implementation for this example, the sixth example can be applicable for at least on of Scenario 2, and/or Scenario 4, and/or Scenario 6, and/or Scenario 8, and/or Scenario 10, and/or Scenario 12, and/or Scenario 14, and/or Scenario 16.

With reference to FIG. 13 an example UE procedure is shown for initial access using dual transceivers.

FIG. 14 illustrates a signal flow of an example procedure 1400 for initial access according to embodiments of the present disclosure. For example, procedure 1400 can be performed by the UE 116 and the gNB 103 and/or network 130 in the wireless network 100 of FIG. 1. This example is for illustration only and other embodiments can be used without departing from the scope of the present disclosure.

In a seventh example, a BS transmits at least a set of LP-SSB 1405 (e.g., using a LR or LTR or MTR), and a set of SSB 1410 (e.g., using a MTR), and a SIB1 1415 (e.g., using a MTR), and at least a set of LP-WUS 1420 (e.g., using a LR or LTR or MTR), and a UE, for initial access to the BS, may first receive at least one LP-SSB from the set of LP-SSB 1405 (e.g., using a LR or LTR), and then receive at least one SSB from the set of SSBs 1410 (e.g., using a MTR). The UE can further receive SIB1 from the BS 1415 (e.g., using a MTR), and at least one LP-WUS from the set of LP-WUS 1420 (e.g., using a LR or LTR), and then transmit a PRACH to the BS 1425 (e.g., using a MTR). An illustration of this example is shown in FIG. 14.

In one implementation for this example, a UE can acquire downlink synchronization based on LP-SSB and SSB, wherein the UE may acquire a first part of timing information based on the reception of LP-SSB, and acquire a second part of timing information based on the reception of SSB.

In another implementation for this example, a set of configurations for the SSB can be carried and/or indicated (explicitly or implicitly) by the LP-SSB.

In yet another implementation for this example, a set of configurations for the LP-WUS can be carried and/or indicated (explicitly or implicitly) by the SSB.

In yet another implementation for this example, a set of configurations for the LP-WUS can be carried and/or indicated (explicitly or implicitly) by the LP-SSB.

In yet another implementation for this example, a set of configurations for the LP-WUS can be carried and/or indicated (explicitly or implicitly) by the SIB1.

In yet another implementation for this example, a set of configurations for the SIB1 can be carried and/or indicated (explicitly or implicitly) by the SSB.

In yet another implementation for this example, a set of configurations for the PRACH can be carried and/or indicated (explicitly or implicitly) by the SIB1.

In yet another implementation for this example, a set of configurations for the PRACH can be carried and/or indicated (explicitly or implicitly) by the LP-WUS.

In yet another implementation for this example, the seventh example can be applicable for at least on of Scenario 2, and/or Scenario 4, and/or Scenario 6, and/or Scenario 8, and/or Scenario 10, and/or Scenario 12, and/or Scenario 14, and/or Scenario 16.

With reference to FIG. 14, an example UE procedure is shown for initial access using dual transceivers.

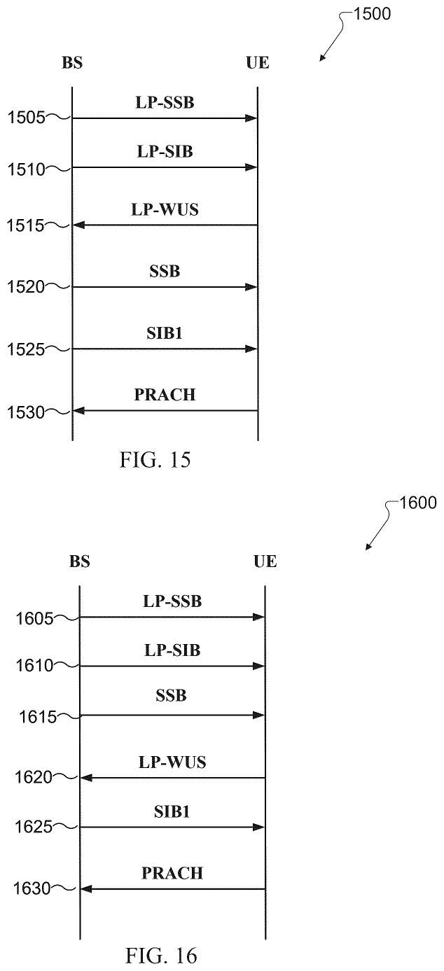

FIG. 15 illustrates a signal flow of an example procedure 1500 for initial access according to embodiments of the present disclosure. For example, procedure 1500 can be performed by the UE 115 and the gNB 103 and/or network 130 in the wireless network 100 of FIG. 1. This example is for illustration only and other embodiments can be used without departing from the scope of the present disclosure.

In an eighth example, a BS transmits at least a set of LP-SSB 1505 (e.g., using a LR or LTR or MTR), and at least a set of LP-SIB 1510 (e.g., using a LR or LTR or MTR), and a UE, for initial access to the BS, may first receive at least one LP-SSB from the set of LP-SSB 1505 (e.g., using a LR or LTR), and then receive at least one LP-SIB from the set of LP-SIB 1510 (e.g., using a LR or LTR), and then transmit a LP-WUS to the BS 1515 (e.g., using a LT or LTR). The BS first receives a LP-WUS 1515 (e.g., using a LR or LTR or MTR), and then transmits a set of SSB 1520 (e.g., using a MTR), and a SIB1 1525 (e.g., using a MTR), and UE can receive at least one SSB from the set of SSBs 1520 (e.g., using a MTR), and then receive a SIB1 from the BS 1525 (e.g., using a MTR), and next transmit a PRACH to the BS 1530 (e.g., using a MTR). An illustration of this example is shown in FIG. 15.

In one implementation for this example, a UE can acquire downlink synchronization based on LP-SSB and SSB, wherein the UE may acquire a first part of timing information based on the reception of LP-SSB, and acquire a second part of timing information based on the reception of SSB. The UE can acquire a first part of system information based on the reception of LP-SIB, and acquire a second part of system information based on the reception of SIB1.

In another implementation for this example, a set of configurations for the SSB can be carried and/or indicated (explicitly or implicitly) by the LP-SSB.

In yet another implementation for this example, a set of configurations for the SSB can be carried and/or indicated (explicitly or implicitly) by the LP-SIB.

In yet another implementation for this example, a set of configurations for the SSB can be carried and/or indicated (explicitly or implicitly) by the LP-WUS.

In yet another implementation for this example, a request to send SSB can be carried and/or indicated (explicitly or implicitly) by the LP-WUS.

In yet another implementation for this example, a set of configurations for the LP-SIB can be carried and/or indicated (explicitly or implicitly) by the LP-SSB.

In yet another implementation for this example, a set of configurations for the SIB1 can be carried and/or indicated (explicitly or implicitly) by the SSB.

In yet another implementation for this example, a set of configurations for the PRACH can be carried and/or indicated (explicitly or implicitly) by the SIB1.

In yet another implementation for this example, a set of configurations for the LP-WUS can be carried and/or indicated (explicitly or implicitly) by the LP-SIB.

In yet another implementation for this example, the eighth example can be applicable for at least on of Scenario 4, and/or Scenario 8, and/or Scenario 12, and/or Scenario 16.

With reference to FIG. 15, an example UE procedure is shown for initial access using dual transceivers.

FIG. 16 illustrates a signal flow of an example procedure 1600 for initial access according to embodiments of the present disclosure. For example, procedure 1600 can be performed by the UE 114 and the gNB 103 and/or network 130 in the wireless network 100 of FIG. 1. This example is for illustration only and other embodiments can be used without departing from the scope of the present disclosure.

In a ninth example, a BS transmits at least a set of LP-SSB 1605 (e.g., using a MTR or LT or LTR), and at least a set of LP-SIB 1610 (e.g., using a MTR or LT or LTR), and a set of SSB 1615 (e.g., using a MTR), and a UE, for initial access to the BS, may first receive at least one LP-SSB from the set of LP-SSB 1605 (e.g., using a LR or LTR), and at least one LP-SIB from the set of LP-SIB 1610 (e.g., using a LR or LTR), and at least one SSB from the set of SSBs 1615 (e.g., using a MTR). The UE may transmit a LP-WUS 1620 (e.g., using a LR or LTR), and a BS can receive a LP-WUS 1620 (e.g., using a MTR or LR or LTR), and then transmit a SIB1 1625 (e.g., using a MTR). The UE may further receive a SIB1 from the BS 1625 (e.g., using a MTR), and then transmit a PRACH to the BS 1630 (e.g., using a MTR). An illustration of this example is shown in FIG. 16.

In one implementation for this example, a UE (e.g., the UE 116) can acquire downlink synchronization based on LP-SSB and SSB, wherein the UE may acquire a first part of timing information based on the reception of LP-SSB, and acquire a second part of timing information based on the reception of SSB. The UE can acquire a first part of system information based on the reception of LP-SIB, and acquire a second part of system information based on the reception of SIB1.

In another implementation for this example, a set of configurations for the SSB can be carried and/or indicated (explicitly or implicitly) by the LP-SSB.

In yet another implementation for this example, a set of configurations for the SSB can be carried and/or indicated (explicitly or implicitly) by the LP-SIB.

In yet another implementation for this example, a request to send SIB1 from BS can be carried and/or indicated (explicitly or implicitly) by the LP-WUS.

In yet another implementation for this example, a set of configurations for the SIB1 can be carried and/or indicated (explicitly or implicitly) by the LP-WUS.

In yet another implementation for this example, a set of configurations for the SIB1 can be carried and/or indicated (explicitly or implicitly) by the SSB.

In yet another implementation for this example, a set of configurations for the PRACH can be carried and/or indicated (explicitly or implicitly) by the SIB1.

In yet another implementation for this example, the ninth example can be applicable for at least on of Scenario 4, and/or Scenario 8, and/or Scenario 12, and/or Scenario 16.

With reference to FIG. 16, an example UE procedure is shown for initial access using dual transceivers.

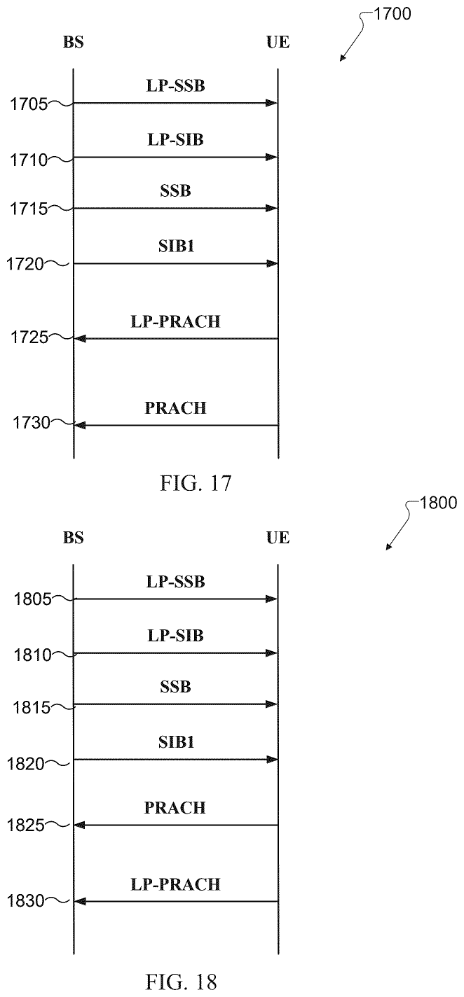

FIG. 17 illustrates a signal flow of an example procedure 1700 for initial access according to embodiments of the present disclosure. For example, procedure 1700 can be performed by the UE 113 and the gNB 103 and/or network 130 in the wireless network 100 of FIG. 1. This example is for illustration only and other embodiments can be used without departing from the scope of the present disclosure.

In a tenth example, a BS transmits at least a set of LP-SSB 1705 (e.g., using a MTR or LT or LTR), and at least a set of LP-SIB 1710 (e.g., using a MTR or LT or LTR), and a set of SSB 1715 (e.g., using a MTR), and a SIB1 1720 (e.g., using a MTR), and a UE, for initial access to the BS, may first receive at least one LP-SSB from the set of LP-SSB 1705 (e.g., using a LR or LTR), and then receive at least one LP-SIB from the set of LP-SIB 1710 (e.g., using a LR or LTR), and then receive at least one SSB from the set of SSBs 1715 (e.g., using a MTR). The UE can further receive a SIB1 from the BS 1720 (e.g., using a MTR), and then transmit a LP-PRACH to the BS 1725 (e.g., using a LT or LTR), and next transmit a PRACH to the BS 1730 (e.g., using a MTR). An illustration of this example is shown in FIG. 17.

In one implementation for this example, a UE can acquire downlink synchronization based on LP-SSB and SSB, wherein the UE may acquire a first part of timing information based on the reception of LP-SSB, and acquire a second part of timing information based on the reception of SSB. The UE can acquire a first part of system information based on the reception of LP-SIB, and acquire a second part of system information based on the reception of SIB1.

In another implementation for this example, a set of configurations for the SSB can be carried and/or indicated (explicitly or implicitly) by the LP-SSB.

In yet another implementation for this example, a set of configurations for the SSB can be carried and/or indicated (explicitly or implicitly) by the LP-SIB.

In yet another implementation for this example, a set of configurations for the LP-SIB can be carried and/or indicated (explicitly or implicitly) by the LP-SSB.

In yet another implementation for this example, a set of configurations for the SIB1 can be carried and/or indicated (explicitly or implicitly) by the SSB.

In yet another implementation for this example, a set of configurations for the SIB1 can be carried and/or indicated (explicitly or implicitly) by the LP-SIB.

In yet another implementation for this example, a set of configurations for the PRACH can be carried and/or indicated (explicitly or implicitly) by the SIB1.

In yet another implementation for this example, a set of configurations for the LP-PRACH can be carried and/or indicated (explicitly or implicitly) by the LP-SIB.

In yet another implementation for this example, a set of configurations for the LP-PRACH can be carried and/or indicated (explicitly or implicitly) by the SSB.

In yet another implementation for this example, a set of configurations for the LP-PRACH can be carried and/or indicated (explicitly or implicitly) by the SIB1.

In yet another implementation for this example, the tenth example can be applicable for at least on of Scenario 4, and/or Scenario 8, and/or Scenario 12, and/or Scenario 16.

With reference to FIG. 17, an example UE procedure is shown for initial access using dual transceivers.

FIG. 18 illustrates a signal flow of an example procedure 1800 for initial access according to embodiments of the present disclosure. For example, procedure 1800 can be performed by the UE 112 and the gNB 103 and/or network 130 in the wireless network 100 of FIG. 1. This example is for illustration only and other embodiments can be used without departing from the scope of the present disclosure.

In a eleventh example, a BS transmits at least a set of LP-SSB 1805 (e.g., using a MTR or LT or LTR), and at least a set of LP-SIB 1810 (e.g., using a MTR or LT or LTR), and a set of SSB 1815 (e.g., using a MTR), and a SIB1 1820 (e.g., using a MTR), and a UE, for initial access to the BS, may first receive at least one LP-SSB from the set of LP-SSB 1805 (e.g., using a LR or LTR), and then receive at least one LP-SIB from the set of LP-SIB 1810 (e.g., using a LR or LTR), and then receive at least one SSB from the set of SSBs 1815 (e.g., using a MTR). The UE can further receive a SIB1 from the BS 1820 (e.g., using a MTR), and then transmit a PRACH to the BS 1825 (e.g., using a MTR), and then transmit a LP-PRACH to the BS 1830 (e.g., using a LT or LTR). An illustration of this example is shown in FIG. 18.

In one implementation for this example, a UE can acquire downlink synchronization based on LP-SSB and SSB, wherein the UE may acquire a first part of timing information based on the reception of LP-SSB, and acquire a second part of timing information based on the reception of SSB. The UE can acquire a first part of system information based on the reception of LP-SIB, and acquire a second part of system information based on the reception of SIB1.

In another implementation for this example, a set of configurations for the SSB can be carried and/or indicated (explicitly or implicitly) by the LP-SSB.

In yet another implementation for this example, a set of configurations for the SSB can be carried and/or indicated (explicitly or implicitly) by the LP-SIB.

In yet another implementation for this example, a set of configurations for the LP-SIB can be carried and/or indicated (explicitly or implicitly) by the LP-SSB.

In yet another implementation for this example, a set of configurations for the SIB1 can be carried and/or indicated (explicitly or implicitly) by the SSB.

In yet another implementation for this example, a set of configurations for the SIB1 can be carried and/or indicated (explicitly or implicitly) by the LP-SIB.

In yet another implementation for this example, a set of configurations for the PRACH can be carried and/or indicated (explicitly or implicitly) by the SIB1.

In yet another implementation for this example, a set of configurations for the LP-PRACH can be carried and/or indicated (explicitly or implicitly) by the LP-SIB.

In yet another implementation for this example, a set of configurations for the LP-PRACH can be carried and/or indicated (explicitly or implicitly) by the SSB.

In yet another implementation for this example, a set of configurations for the LP-PRACH can be carried and/or indicated (explicitly or implicitly) by the SIB1.

In yet another implementation for this example, the eleventh example can be applicable for at least on of Scenario 4, and/or Scenario 8, and/or Scenario 12, and/or Scenario 16.

With reference to FIG. 18, an example UE procedure is shown for initial access using dual transceivers.

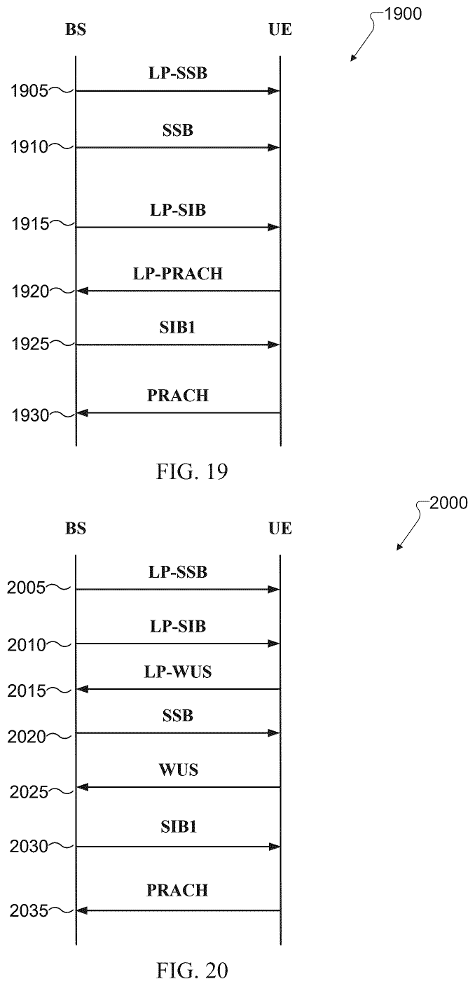

FIG. 19 illustrates a signal flow of an example procedure 1900 for initial access according to embodiments of the present disclosure. For example, procedure 1900 can be performed by the UE 111 and the gNB 103 and/or network 130 in the wireless network 100 of FIG. 1. This example is for illustration only and other embodiments can be used without departing from the scope of the present disclosure.

In a twelfth example, a BS transmits at least a set of LP-SSB 1905 (e.g., using a MTR or LT or LTR), and a set of SSB 1910 (e.g., using a MTR), and at least a set of LP-SIB 1915 (e.g., using a MTR or LT or LTR), and a UE, for initial access to the BS, may first receive at least one LP-SSB from the set of LP-SSB 1905 (e.g., using a LR or LTR), and then receive at least one SSB from the set of SSBs 1910 (e.g., using a MTR), and then receive at least one LP-SIB from the set of LP-SIB 1915 (e.g., using a LR or LTR). The UE can further transmit a LP-PRACH 1920 (e.g., using a LR or LTR), and a UE can receive a SIB1 from the BS 1925 (e.g., using a MTR), and then transmit a PRACH to the BS 1930 (e.g., using a MTR). An illustration of this example is shown in FIG. 19.

In one implementation for this example, a UE can acquire downlink synchronization based on LP-SSB and SSB, wherein the UE may acquire a first part of timing information based on the reception of LP-SSB, and acquire a second part of timing information based on the reception of SSB. The UE can acquire a first part of system information based on the reception of LP-SIB, and acquire a second part of system information based on the reception of SIB1.

In another implementation for this example, a set of configurations for the SSB can be carried and/or indicated (explicitly or implicitly) by the LP-SSB.

In yet another implementation for this example, a set of configurations for the LP-SIB can be carried and/or indicated (explicitly or implicitly) by the LP-SSB.

In yet another implementation for this example, a set of configurations for the LP-SIB can be carried and/or indicated (explicitly or implicitly) by the SSB.

In yet another implementation for this example, a set of configurations for the SIB1 can be carried and/or indicated (explicitly or implicitly) by the SSB.

In yet another implementation for this example, a set of configurations for the SIB1 can be carried and/or indicated (explicitly or implicitly) by the LP-SIB.

In yet another implementation for this example, a set of configurations for the SIB1 can be carried and/or indicated (explicitly or implicitly) by the LP-PRACH.

In yet another implementation for this example, a set of configurations for the PRACH can be carried and/or indicated (explicitly or implicitly) by the SIB1.

In yet another implementation for this example, a set of configurations for the LP-PRACH can be carried and/or indicated (explicitly or implicitly) by the LP-SIB.

In yet another implementation for this example, a set of configurations for the LP-PRACH can be carried and/or indicated (explicitly or implicitly) by the SSB.

In yet another implementation for this example, the twelfth example can be applicable for at least on of Scenario 4, and/or Scenario 8, and/or Scenario 12, and/or Scenario 16.

With reference to FIG. 19, an example UE procedure is shown for initial access using dual transceivers.

FIG. 20 illustrates a signal flow of an example procedure 2000 for initial access according to embodiments of the present disclosure. For example, procedure 2000 can be performed by the UE 111 and the gNB 102 and/or network 130 in the wireless network 100 of FIG. 1. This example is for illustration only and other embodiments can be used without departing from the scope of the present disclosure.

In a thirteenth example, a BS transmits at least a set of LP-SSB 2005 (e.g., using a MTR or LT or LTR), and at least a set of LP-SIB 2010 (e.g., using a MTR), and a UE, for initial access to the BS, may first receive at least one LP-SSB from the set of LP-SSB 2005 (e.g., using a LR or LTR), and then receive at least one LP-SIB from the set of LP-SIB 2010 (e.g., using a LR or LTR), and then transmit a LP-WUS to BS 2015 (e.g., using a LT or LTR). The BS receives a LP-WUS 2015 (e.g., using a LR or LTR), and then transmits a set of SSB 2020 (e.g., using a MTR). The UE receives at least one SSB from the set of SSBs 2020 (e.g., using a MTR), and then can further transmit a WUS 2025 (e.g., using a MTR). The BS may receive a WUS from UE 2025 (e.g., using a MTR), and then transmit a SIB1 2030 (e.g., using a MTR), and a UE can receive a SIB1 from the BS 2030 (e.g., using a MTR), and then transmit a PRACH to the BS 2035 (e.g., using a MTR). An illustration of this example is shown in FIG. 20.

In one implementation for this example, a UE can acquire downlink synchronization based on LP-SSB and SSB, wherein the UE may acquire a first part of timing information based on the reception of LP-SSB, and acquire a second part of timing information based on the reception of SSB. The UE can acquire a first part of system information based on the reception of LP-SIB, and acquire a second part of system information based on the reception of SIB1.

In another implementation for this example, a set of configurations for the SSB can be carried and/or indicated (explicitly or implicitly) by the LP-SSB.

In yet another implementation for this example, a set of configurations for the SSB can be carried and/or indicated (explicitly or implicitly) by the LP-SIB.

In yet another implementation for this example, a set of configurations for the SSB can be carried and/or indicated (explicitly or implicitly) by the LP-WUS.

In yet another implementation for this example, a set of configurations for the LP-WUS can be carried and/or indicated (explicitly or implicitly) by the LP-SIB.

In yet another implementation for this example, a set of configurations for the LP-SIB can be carried and/or indicated (explicitly or implicitly) by the LP-SSB.

In yet another implementation for this example, a request to send SSB from BS can be carried and/or indicated (explicitly or implicitly) by the LP-WUS.

In yet another implementation for this example, a request to send SIB1 from BS can be carried and/or indicated (explicitly or implicitly) by the WUS.

In yet another implementation for this example, a set of configurations for the SIB1 can be carried and/or indicated (explicitly or implicitly) by the LP-SIB.

In yet another implementation for this example, a set of configurations for the SIB1 can be carried and/or indicated (explicitly or implicitly) by the SSB.

In yet another implementation for this example, a set of configurations for the SIB1 can be carried and/or indicated (explicitly or implicitly) by the WUS.

In yet another implementation for this example, a set of configurations for the WUS can be carried and/or indicated (explicitly or implicitly) by the SSB.

In yet another implementation for this example, a set of configurations for the PRACH can be carried and/or indicated (explicitly or implicitly) by the SIB1.

In yet another implementation for this example, the thirteenth example can be applicable for at least on of Scenario 4, and/or Scenario 8, and/or Scenario 12, and/or Scenario 16.

With reference to FIG. 20, an example UE procedure is shown for initial access using dual transceivers.

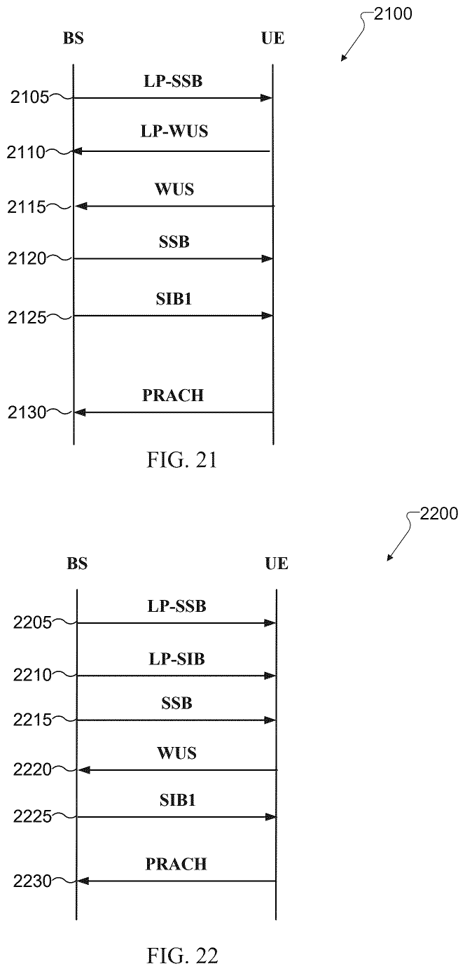

FIG. 21 illustrates a signal flow of an example procedure 2100 for initial access according to embodiments of the present disclosure. For example, procedure 2100 can be performed by the UE 112 and the gNB 102 and/or network 130 in the wireless network 100 of FIG. 1. This example is for illustration only and other embodiments can be used without departing from the scope of the present disclosure.

In a fourteenth example, a BS transmits at least a set of LP-SSB 2105 (e.g., using a MTR or LT or LTR), and a UE, for initial access to the BS, may first receive at least one LP-SSB from the set of LP-SSB 2105 (e.g., using a LR or LTR), and then transmit a LP-WUS to the BS 2110 (e.g., using a LR or LTR), and then transmit a WUS to the BS 2115 (e.g., using a MTR). The BS receives a LP-WUS 2110 (e.g., using a LR or LTR or MTR), and then receives a WUS 2115 (e.g., using a MTR). Next, the BS transmits a set of SSB 2120 (e.g., using a MTR), and a SIB1 2125 (e.g., using a MTR). The UE receives at least one SSB from the set of SSBs 2120 (e.g., using a MTR), a SIB1 from the BS 2125 (e.g., using a MTR), and then transmit a PRACH to the BS 2130 (e.g., using a MTR). An illustration of this example is shown in FIG. 21.

In one implementation for this example, a UE can acquire downlink synchronization based on LP-SSB and SSB, wherein the UE may acquire a first part of timing information based on the reception of LP-SSB, and acquire a second part of timing information based on the reception of SSB.

In another implementation for this example, a set of configurations for the SSB can be carried and/or indicated (explicitly or implicitly) by the LP-SSB.

In yet another implementation for this example, a set of configurations for the SSB can be carried and/or indicated (explicitly or implicitly) by the LP-WUS.

In yet another implementation for this example, a set of configurations for the SSB can be carried and/or indicated (explicitly or implicitly) by the WUS.

In yet another implementation for this example, a request to send SSB from BS can be carried and/or indicated (explicitly or implicitly) by the LP-WUS.

In yet another implementation for this example, a request to send SSB from BS can be carried and/or indicated (explicitly or implicitly) by the WUS.

In yet another implementation for this example, a request to send SIB1 from BS can be carried and/or indicated (explicitly or implicitly) by the WUS.

In yet another implementation for this example, a set of configurations for the SIB1 can be carried and/or indicated (explicitly or implicitly) by the SSB.

In yet another implementation for this example, a set of configurations for the SIB1 can be carried and/or indicated (explicitly or implicitly) by the WUS.

In yet another implementation for this example, a set of configurations for the WUS can be carried and/or indicated (explicitly or implicitly) by the LP-WUS.

In yet another implementation for this example, a set of configurations for the PRACH can be carried and/or indicated (explicitly or implicitly) by the SIB1.

In yet another implementation for this example, the fourteenth example can be applicable for at least on of Scenario 4, and/or Scenario 8, and/or Scenario 12, and/or Scenario 16.

With reference to FIG. 21, an example UE procedure is shown for initial access using dual transceivers.

FIG. 22 illustrates a signal flow of an example procedure 2200 for initial access according to embodiments of the present disclosure. For example, procedure 2200 can be performed by the UE 113 and the gNB 102 and/or network 130 in the wireless network 100 of FIG. 1. This example is for illustration only and other embodiments can be used without departing from the scope of the present disclosure.

In a fifteenth example, a BS transmits at least a set of LP-SSB 2205 (e.g., using a MTR or LT or LTR), and at least a set of LP-SIB 2210 (e.g., using a MTR or LT or LTR), and a set of SSB 2215 (e.g., using a MTR), and a UE, for initial access to the BS, may first receive at least one LP-SSB from the set of LP-SSB 2205 (e.g., using a LR or LTR), and at least one LP-SIB from the set of LP-SIB 2210 (e.g., using a LR or LTR), and at least one SSB from the set of SSBs 2215 (e.g., using a MTR). The UE may transmit a WUS 2220 (e.g., using a MTR), and a BS can receive a WUS 2220 (e.g., using a MTR), and then transmit a SIB1 2225 (e.g., using a MTR). The UE may further receive a SIB1 from the BS 2225 (e.g., using a MTR), and then transmit a PRACH to the BS 2230 (e.g., using a MTR). An illustration of this example is shown in FIG. 22.

In one implementation for this example, a UE can acquire downlink synchronization based on LP-SSB and SSB, wherein the UE may acquire a first part of timing information based on the reception of LP-SSB, and acquire a second part of timing information based on the reception of SSB. The UE can acquire a first part of system information based on the reception of LP-SIB, and acquire a second part of system information based on the reception of SIB1.

In another implementation for this example, a set of configurations for the SSB can be carried and/or indicated (explicitly or implicitly) by the LP-SSB.

In yet another implementation for this example, a set of configurations for the SSB can be carried and/or indicated (explicitly or implicitly) by the LP-SIB.

In yet another implementation for this example, a request to send SIB1 from BS can be carried and/or indicated (explicitly or implicitly) by the WUS.

In yet another implementation for this example, a set of configurations for the SIB1 can be carried and/or indicated (explicitly or implicitly) by the WUS.

In yet another implementation for this example, a set of configurations for the SIB1 can be carried and/or indicated (explicitly or implicitly) by the SSB.

In yet another implementation for this example, the fifteenth example can be applicable for at least on of Scenario 2, and/or Scenario 4, and/or Scenario 6, and/or Scenario 8, and/or Scenario 10, and/or Scenario 12, and/or Scenario 14, and/or Scenario 16.

With reference to FIG. 22 an example UE procedure is shown for initial access using dual transceivers.

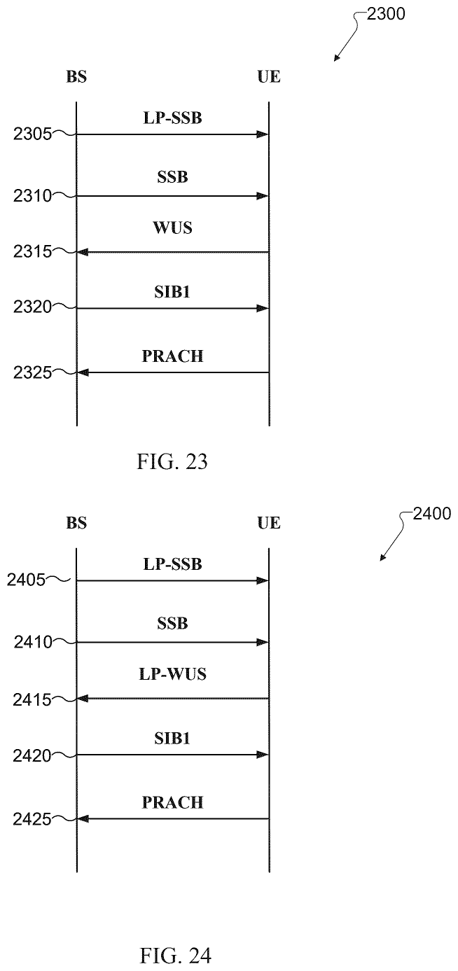

FIG. 23 illustrates a signal flow of an example procedure 2300 for initial access according to embodiments of the present disclosure. For example, procedure 2300 can be performed by the UE 114 and the gNB 102 and/or network 130 in the wireless network 100 of FIG. 1. This example is for illustration only and other embodiments can be used without departing from the scope of the present disclosure.

In a sixteenth example, a BS transmits at least a set of LP-SSB 2305 (e.g., using a MTR or LT or LTR), and a set of SSB 2310 (e.g., using a MTR), and a UE, for initial access to the BS, may first receive at least one LP-SSB from the set of LP-SSB 2305 (e.g., using a LR or LTR), and then receive at least one SSB from the set of SSBs 2310 (e.g., using a MTR), and next transmit a WUS to the BS 2315 (e.g., using a MTR). The BS receives a WUS 2315 (e.g., using a MTR), and then transmits a SIB1 2320(e.g., using a MTR). The UE can further receive a SIB1 from the BS 2320 (e.g., using a MTR), and transmit a PRACH to the BS 2325 (e.g., using a MTR). An illustration of this example is shown in FIG. 23.

In one implementation for this example, a UE can acquire downlink synchronization based on LP-SSB and SSB, wherein the UE may acquire a first part of timing information based on the reception of LP-SSB, and acquire a second part of timing information based on the reception of SSB.

In another implementation for this example, a set of configurations for the SSB can be carried and/or indicated (explicitly or implicitly) by the LP-SSB.

In yet another implementation for this example, a set of configurations for the WUS can be carried and/or indicated (explicitly or implicitly) by the SSB.

In yet another implementation for this example, a set of configurations for the WUS can be carried and/or indicated (explicitly or implicitly) by the LP-SSB.

In yet another implementation for this example, a set of configurations for the SIB1 can be carried and/or indicated (explicitly or implicitly) by the SSB.

In yet another implementation for this example, a request to send the SIB1 can be carried and/or indicated (explicitly or implicitly) by the WUS.

In yet another implementation for this example, a set of configurations for the SIB1 can be carried and/or indicated (explicitly or implicitly) by the WUS.

In yet another implementation for this example, a set of configurations for the PRACH can be carried and/or indicated (explicitly or implicitly) by the SIB1.

In yet another implementation for this example, the sixteenth example can be applicable for at least on of Scenario 2, and/or Scenario 4, and/or Scenario 6, and/or Scenario 8, and/or Scenario 10, and/or Scenario 12, and/or Scenario 14, and/or Scenario 16.

With reference to FIG. 23, an example UE procedure is shown for initial access using dual transceivers.

FIG. 24 illustrates a signal flow of an example procedure 2400 for initial access according to embodiments of the present disclosure. For example, procedure 2400 can be performed by the UE 115 and the gNB 102 and/or network 130 in the wireless network 100 of FIG. 1. This example is for illustration only and other embodiments can be used without departing from the scope of the present disclosure.

In a seventeenth example, a BS transmits at least a set of LP-SSB 2405 (e.g., using a MTR or LT or LTR), and a set of SSB 2410 (e.g., using a MTR), and a UE, for initial access to the BS, may first receive at least one LP-SSB from the set of LP-SSB 2405 (e.g., using a LR or LTR), and then receive at least one SSB from the set of SSBs 2410 (e.g., using a MTR), and next transmit a LP-WUS to the BS 2415 (e.g., using a LT or LTR or MTR). The BS receives a LP-WUS 2415 (e.g., using a LR or LTR or MTR), and then transmits a SIB1 2420 (e.g., using a MTR). The UE can further receive SIB1 from the BS 2420 (e.g., using a MTR), and transmit a PRACH to the BS 2425 (e.g., using a MTR). An illustration of this example is shown in FIG. 24.

In one implementation for this example, a UE (e.g., the UE 116) can acquire downlink synchronization based on LP-SSB and SSB, wherein the UE may acquire a first part of timing information based on the reception of LP-SSB, and acquire a second part of timing information based on the reception of SSB.

In another implementation for this example, a set of configurations for the SSB can be carried and/or indicated (explicitly or implicitly) by the LP-SSB.

In yet another implementation for this example, a set of configurations for the LP-WUS can be carried and/or indicated (explicitly or implicitly) by the SSB.

In yet another implementation for this example, a set of configurations for the LP-WUS can be carried and/or indicated (explicitly or implicitly) by the LP-SSB.

In yet another implementation for this example, a set of configurations for the SIB1 can be carried and/or indicated (explicitly or implicitly) by the SSB.

In yet another implementation for this example, a request to send the SIB1 can be carried and/or indicated (explicitly or implicitly) by the LP-WUS.

In yet another implementation for this example, a set of configurations for the SIB1 can be carried and/or indicated (explicitly or implicitly) by the LP-WUS.

In yet another implementation for this example, a set of configurations for the PRACH can be carried and/or indicated (explicitly or implicitly) by the SIB1.

In yet another implementation for this example, the seventeenth example can be applicable for at least on of Scenario 4, and/or Scenario 8, and/or Scenario 12, and/or Scenario 16.

With reference to FIG. 24 an example UE procedure is shown for initial access using dual transceivers.

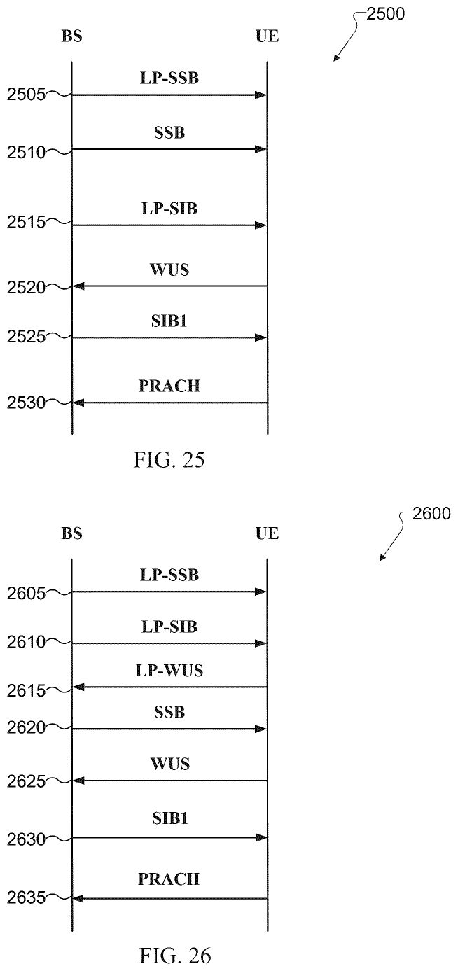

FIG. 25 illustrates a signal flow of an example procedure 2500 for initial access according to embodiments of the present disclosure. For example, procedure 2500 can be performed by the UE 116 and the gNB 102 and/or network 130 in the wireless network 100 of FIG. 1. This example is for illustration only and other embodiments can be used without departing from the scope of the present disclosure.

In a eighteenth example, a BS transmits at least a set of LP-SSB 2505 (e.g., using a LR or LTR or MTR), and a set of SSB 2510 (e.g., using a MTR), and at least a set of LP-SIB 2515 (e.g., using a LR or LTR or MTR), and a UE, for initial access to the BS, may first receive at least one LP-SSB from the set of LP-SSB 2505 (e.g., using a LR or LTR), and then receive at least one SSB from the set of SSBs 2510 (e.g., using a MTR), and then receive at least one LP-SIB from the set of LP-SIB 2515 (e.g., using a LR or LTR), and next transmit a WUS 2520 (e.g., using a MTR). The BS receives a WUS 2520 (e.g., using a MTR), and then transmits a SIB1 2525 (e.g., using a MTR). The UE can further receive a SIB1 from the BS 2525 (e.g., using a MTR), and then transmit a PRACH to the BS 2530 (e.g., using a MTR). An illustration of this example is shown in FIG. 25.

In one implementation for this example, a UE can acquire downlink synchronization based on LP-SSB and SSB, wherein the UE may acquire a first part of timing information based on the reception of LP-SSB, and acquire a second part of timing information based on the reception of SSB. The UE can acquire a first part of system information based on the reception of LP-SIB, and acquire a second part of system information based on the reception of SIB1.

In another implementation for this example, a set of configurations for the SSB can be carried and/or indicated (explicitly or implicitly) by the LP-SSB.

In yet another implementation for this example, a set of configurations for the LP-SIB can be carried and/or indicated (explicitly or implicitly) by the LP-SSB.

In yet another implementation for this example, a set of configurations for the LP-SIB can be carried and/or indicated (explicitly or implicitly) by the SSB.

In yet another implementation for this example, a set of configurations for the SIB1 can be carried and/or indicated (explicitly or implicitly) by the SSB.

In yet another implementation for this example, a set of configurations for the SIB1 can be carried and/or indicated (explicitly or implicitly) by the LP-SIB.

In yet another implementation for this example, a set of configurations for the SIB1 can be carried and/or indicated (explicitly or implicitly) by the WUS.

In yet another implementation for this example, a set of configurations for the PRACH can be carried and/or indicated (explicitly or implicitly) by the SIB1.

In yet another implementation for this example, a set of configurations for the WUS can be carried and/or indicated (explicitly or implicitly) by the LP-SIB.

In yet another implementation for this example, a set of configurations for the WUS can be carried and/or indicated (explicitly or implicitly) by the SSB.

In yet another implementation for this example, the eighteenth example can be applicable for at least on of Scenario 2, and/or Scenario 4, and/or Scenario 6, and/or Scenario 8, and/or Scenario 10, and/or Scenario 12, and/or Scenario 14, and/or Scenario 16.

With reference to FIG. 25, an example UE procedure is shown for initial access using dual transceivers.

FIG. 26 illustrates a signal flow of an example procedure 2600 for initial access according to embodiments of the present disclosure. For example, procedure 2600 can be performed by the UE 116 and the gNB 103 and/or network 130 in the wireless network 100 of FIG. 1. This example is for illustration only and other embodiments can be used without departing from the scope of the present disclosure.

In a nineteenth example, a BS transmits at least a set of LP-SSB 2605 (e.g., using a MTR or LT or LTR), and then transmit at least a set of LP-SIB 2610, and a UE, for initial access to the BS, may first receive at least one LP-SSB from the set of LP-SSB 2605 (e.g., using a LR or LTR), and then may receive at least one LP-SIB from the set of LP-SIB 2610, and then transmit a LP-WUS to BS 2615 (e.g., using a LT or LTR). The BS receives a LP-WUS 2615 (e.g., using a LR or LTR), and then transmits a set of SSB 2620 (e.g., using a MTR). The UE receives at least one SSB from the set of SSBs 2620 (e.g., using a MTR), and then can further transmit a WUS 2625 (e.g., using a MTR). The BS may receive a WUS from UE 2625 (e.g., using a MTR), and then transmit a SIB1 2630 (e.g., using a MTR), and a UE can receive a SIB1 from the BS 2630 (e.g., using a MTR), and then transmit a PRACH to the BS 2635 (e.g., using a MTR). An illustration of this example is shown in FIG. 26.

In one implementation for this example, a UE can acquire downlink synchronization based on LP-SSB and SSB, wherein the UE may acquire a first part of timing information based on the reception of LP-SSB, and acquire a second part of timing information based on the reception of SSB. The UE can acquire a first part of system information based on the reception of LP-SIB, and acquire a second part of system information based on the reception of SIB1.

In another implementation for this example, a set of configurations for the SSB can be carried and/or indicated (explicitly or implicitly) by the LP-SSB.

In yet another implementation for this example, a set of configurations for the SSB can be carried and/or indicated (explicitly or implicitly) by the LP-WUS.

In yet another implementation for this example, a request to send SSB from BS can be carried and/or indicated (explicitly or implicitly) by the LP-WUS.

In yet another implementation for this example, a request to send SIB1 from BS can be carried and/or indicated (explicitly or implicitly) by the WUS.

In yet another implementation for this example, a set of configurations for the SIB1 can be carried and/or indicated (explicitly or implicitly) by the LP-WUS.

In yet another implementation for this example, a set of configurations for the SIB1 can be carried and/or indicated (explicitly or implicitly) by the SSB.

In yet another implementation for this example, a set of configurations for the SIB1 can be carried and/or indicated (explicitly or implicitly) by the WUS.

In yet another implementation for this example, a set of configurations for the WUS can be carried and/or indicated (explicitly or implicitly) by the SSB.

In yet another implementation for this example, a set of configurations for the PRACH can be carried and/or indicated (explicitly or implicitly) by the SIB1.

In yet another implementation for this example, the nineteenth example can be applicable for at least on of Scenario 4, and/or Scenario 8, and/or Scenario 12, and/or Scenario 16.

With reference to FIG. 26, an example UE procedure is shown for initial access using dual transceivers.

In various examples of the present disclosure, a configuration for a LP-SSB can include at least one from: 1) whether the LP-SSB is present; 2) time domain information on the resources of LP-SSB (e.g., periodicity, and/or time offset, and/or transmission duration, and/or starting slot, and/or starting OFDM symbol); 3) frequency domain information on the resources of LP-SSB (e.g., starting or center RB or subcarrier, and/or bandwidth as a number of RBs or subcarriers, and/or frequency offset, and/or bandwidth part or carrier information); 4) power domain information on the resources of LP-SSB (e.g., energy per resource element (EPRE) or EPRE offset to SSB); 5) code domain information on LP-SSB (e.g., cover code information for the LP-SSB); 6) parameter for sequence generation for the signals in LP-SSB (e.g., initial condition of the sequence, and/or cyclic shift of the sequence, and/or root index of the sequence, and/or phase shift of the sequence, or cover code of the sequence).

In various examples of the present disclosure, a configuration for a SSB can include at least one from: 1) whether the SSB is present; 2) time domain information on the resources of SSB (e.g., periodicity, and/or time offset, and/or transmission duration, and/or starting slot, and/or starting OFDM symbol); 3) frequency domain information on the resources of SSB (e.g., starting or center RB or subcarrier, and/or bandwidth as a number of RBs or subcarriers, and/or frequency offset, and/or bandwidth part or carrier information); 4) power domain information on the resources of SSB (e.g., EPRE or EPRE offset to LP-SSB); 5) code domain information on SSB (e.g., cover code information for the SSB); 6) parameter for sequence generation for the signals in SSB (e.g., initial condition of the sequence, and/or cyclic shift of the sequence, and/or root index of the sequence, and/or phase shift of the sequence, or cover code of the sequence).

In various examples of the present disclosure, a configuration for a LP-SIB can include at least one from: 1) whether the LP-SIB is present; 2) time domain information on the resources of LP-SIB (e.g., periodicity, and/or time offset, and/or transmission duration, and/or starting slot, and/or starting OFDM symbol); 3) frequency domain information on the resources of LP-SIB (e.g., starting or center RB or subcarrier, and/or bandwidth as a number of RBs or subcarriers, and/or frequency offset, and/or bandwidth part or carrier information); 4) power domain information on the resources of LP-SIB (e.g., EPRE or EPRE offset to LP-SSB or SSB); 5) code domain information on LP-SIB (e.g., cover code information for the LP-SIB).

In various examples of the present disclosure, a configuration for a SIB1 can include at least one from: 1) whether the SIB1 is present; 2) time domain information on the resources of SIB1 (e.g., periodicity, and/or time offset, and/or transmission duration, and/or starting slot, and/or starting OFDM symbol); 3) frequency domain information on the resources of SIB1 (e.g., starting or center RB or subcarrier, and/or bandwidth as a number of RBs or subcarriers, and/or frequency offset, and/or bandwidth part or carrier information); 4) power domain information on the resources of SIB1 (e.g., EPRE or EPRE offset to LP-SSB or SSB or LP-SIB); 5) configuration for a physical downlink control channel (PDCCH) for the SIB1 (e.g., control resource set (CORESET) information for the PDCCH, and/or search space set information for the PDCCH).

In various examples of the present disclosure, a configuration for a LP-WUS can include at least one from: 1) whether the LP-WUS is present; 2) time domain information on the resources of LP-WUS (e.g., periodicity, and/or time offset, and/or transmission duration, and/or starting slot, and/or starting OFDM symbol); 3) frequency domain information on the resources of LP-WUS (e.g., starting or center RB or subcarrier, and/or bandwidth as a number of RBs or subcarriers, and/or frequency offset, and/or bandwidth part or carrier information); 4) power domain information on the resources of LP-WUS (e.g., energy per resource element (EPRE) or EPRE offset to SSB or LP-SSB); 5) code domain information on LP-WUS (e.g., cover code information for the LP-WUS); 6) parameter for sequence generation for the signals in LP-WUS (e.g., initial condition of the sequence, and/or cyclic shift of the sequence, and/or root index of the sequence, and/or phase shift of the sequence, or cover code of the sequence).

In various examples of the present disclosure, a configuration for a PRACH can include at least one from: 1) whether the PRACH is present; 2) time domain information on the resources of PRACH (e.g., periodicity, and/or time offset, and/or transmission duration, and/or starting slot, and/or starting OFDM symbol); 3) frequency domain information on the resources of PRACH (e.g., starting or center RB or subcarrier, and/or bandwidth as a number of RBs or subcarriers, and/or frequency offset, and/or bandwidth part or carrier information); 4) power domain information on the resources of PRACH (e.g., EPRE or EPRE offset to LP-SSB or SSB or LP-WUS); 5) code domain information on PRACH (e.g., cover code information for the PRACH); 6) parameter for sequence generation for the signals in PRACH (e.g., initial condition of the sequence, and/or cyclic shift of the sequence, and/or root index of the sequence, and/or phase shift of the sequence, or cover code of the sequence).

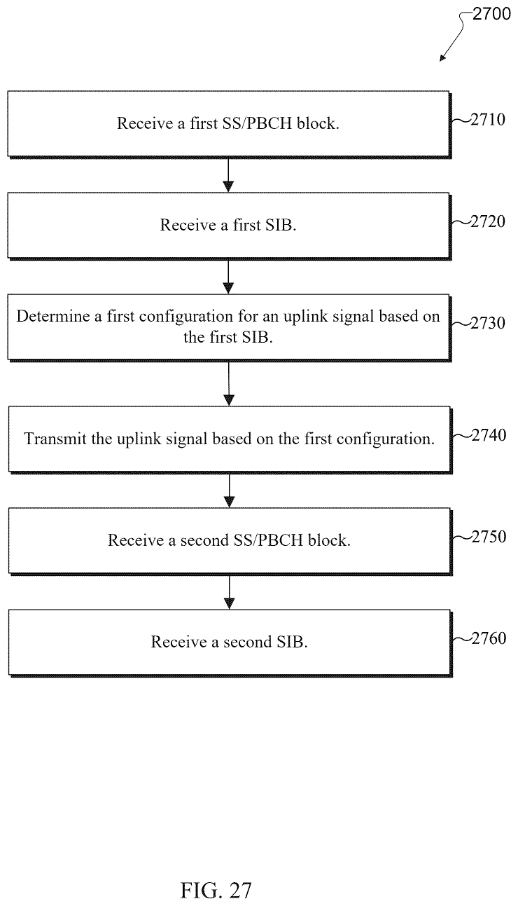

FIG. 27 illustrates an example method 2700 performed by a UE in a wireless communication system according to embodiments of the present disclosure. The method 2700 of FIG. 27 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2700 is for illustration only and other embodiments can be used without departing from the scope of the present disclosure.

The method 2700 begins with the UE receiving a first SS/PBCH block (2710). The UE then receives a first SIB (2720). The UE then determines a first configuration for an uplink signal based on the first SIB (2730). The UE then transmits the uplink signal based on the first configuration (2740). The UE then receives a second SS/PBCH block (2750). The UE then receives a second SIB (2760).

In various embodiments, the UE determines a first part of timing information based on the first SS/PBCH block and determines a second part of the timing information based on the second SS/PBCH block. In various embodiments, the UE determines a first part of system information based on the first SIB and a second part of the system information based on the second SIB.

In various embodiments, the UE determines a second configuration for the second SS/PBCH block based on the first SIB. In various embodiments, the UE determines a second configuration for the second SS/PBCH block and the second configuration is included in the uplink signal.

In various embodiments, the UE determines a request for a transmission of the second SS/PBCH block, and the request is included in the uplink signal. In various embodiments, the UE determines a second configuration for a PRACH based on the second SIB and transmits the PRACH based on the second configuration.

Any of the above variation embodiments can be utilized independently or in combination with at least one other variation embodiment. The above flowchart illustrates example methods that can be implemented in accordance with the principles of the present disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to:
receive a first synchronization signals and physical broadcast channel (SS/PBCH) block; and
receive a first system information block (SIB); and
a processor operably coupled to the transceiver, the processor configured to determine, based on the first SIB, a first configuration for an uplink signal,
wherein the transceiver is further configured to:
transmit the uplink signal based on the first configuration;
receive a second SS/PBCH block; and
receive a second SIB.

2. The UE of claim 1, wherein the processor is further configured to:
determine, based on the first SS/PBCH block, a first part of timing information; and
determine, based on the second SS/PBCH block, a second part of the timing information.

3. The UE of claim 1, wherein the processor is further configured to:
determine, based on the first SIB, a first part of system information; and
determine, based on the second SIB, a second part of the system information.

4. The UE of claim 1, wherein the processor is further configured to determine, based on the first SIB, a second configuration for the second SS/PBCH block.

5. The UE of claim 1, wherein:
the processor is further configured to determine a second configuration for the second SS/PBCH block, and
the second configuration is included in the uplink signal.

6. The UE of claim 1, wherein the processor is further configured to determine a request for a transmission of the second SS/PBCH block, and the request is included in the uplink signal.

7. The UE of claim 1, wherein:
the processor is further configured to determine, based on the second SIB, a second configuration for a physical random access channel (PRACH); and
the transceiver is further configured to transmit the PRACH based on the second configuration.

8. A method of a user equipment (UE) in a wireless communication system, the method comprising:
receiving a first synchronization signals and physical broadcast channel (SS/PBCH) block;
receiving a first system information block (SIB);
determining, based on the first SIB, a first configuration for an uplink signal;
transmitting the uplink signal based on the first configuration;
receiving a second SS/PBCH block; and
receiving a second SIB.

9. The method of claim 8, further comprising:
determining, based on the first SS/PBCH block, a first part of timing information; and
determining, based on the second SS/PBCH block, a second part of the timing information.

10. The method of claim 8, further comprising:
determining, based on the first SIB, a first part of system information; and
determining, based on the second SIB, a second part of the system information.

11. The method of claim 8, further comprising:
determining, based on the first SIB, a second configuration for the second SS/PBCH block.

12. The method of claim 8, further comprising:
determining a second configuration for the second SS/PBCH block, and the second configuration is included in the uplink signal.

13. The method of claim 8, further comprising:
determining a request for a transmission of the second SS/PBCH block,
wherein the request is included in the uplink signal.

14. The method of claim 8, further comprising:
determining, based on the second SIB, a second configuration for a physical random access channel (PRACH); and
transmitting the PRACH based on the second configuration.

15. A base station (BS) in a wireless communication system, the BS comprising:
a processor configured to determine a first configuration for an uplink signal; and
a transceiver operably coupled to the processor, the transceiver configured to:
transmit a first synchronization signals and physical broadcast channel (SS/PBCH) block;
transmit a first system information block (SIB), and the first configuration is included in the first SIB;
receive the uplink signal based on the first configuration;
transmit a second SS/PBCH block; and
transmit a second SIB.

16. The BS of claim 15, wherein the processor is further configured to:
determine a first part of system information that is included in the first SIB; and
determine a second part of system information that is included in the second SIB.

17. The BS of claim 15, wherein:
the processor is further configured to determine a second configuration for the second SS/PBCH block, and
the second configuration is included in the first SIB.

18. The BS of claim 15, wherein:
the processor is further configured to determine a second configuration for the second SS/PBCH block, and
the second configuration is included in the uplink signal.

19. The BS of claim 15, wherein:
the processor is further configured to determine a request for a transmission of the second SS/PBCH block, and
the request is included in the uplink signal.

20. The BS of claim 15, wherein:
the processor is further configured to determine a second configuration for a physical random access channel (PRACH),
the second configuration is included in the second SIB, and
the transceiver is further configured to receive the PRACH based on the second configuration.
